(19) United States
(12) Patent Application Publication
(10) Pub. No.: US 2011/0215941 A1
(43) Pub. Date: Sep. 8, 2011

(54) Fueling Status Monitor and Alarm

(76) Inventor: Nicholas Iozzo, Geneva, IL (US)

(21) Appl. No.: 12/716,268

(22) Filed: Mar. 2, 2010

(51) Int. Cl. G08B 21/00

(52) U.S. Cl. 340/686.6; 340/540

(57) ABSTRACT

A device fueling status monitor and alarm includes: a portable powered device; a refueling energy source adapted to refuel the portable powered device; a monitor associated with either the portable powered device or the refueling energy source, wherein the monitor monitors conditions of the portable powered device or the refueling energy source to detect alarm conditions, wherein the monitored conditions include the proximity of the portable powered device to the refueling energy source and whether the portable powered device is being refueled; an alarm condition transmitter associated with the monitor and adapted to transmit an alarm signal when alarm conditions are recognized by the monitor; and an alarm condition receiver adapted to receive signals from the alarm condition transmitter and signal an alarm condition to a user.

### BACKGROUND OF THE INVENTION

The present subject matter relates generally to a fueling status monitor and alarm. Specifically, the present subject matter relates to a system and method for monitoring the refueling status of a device and alerting a caretaker of the device if the status violates given preset conditions.

There are an ever increasing number of portable electrical devices that rely on rechargeable batteries for their power source. For example, such devices include everything from cellular phones to electric vehicles. As our reliance on these portable electrical devices increases, the importance of monitoring their power status increases as well. The same issues apply to any portable powered device that relies on a refillable power source, such as, for example, gasoline, compressed natural gas, compressed air, hydrogen, etc.

Accordingly, a need exists for a system and for monitoring the refueling status of a device and alert a caretaker of the device if the status violates given preset conditions.

### BRIEF SUMMARY OF THE INVENTION

The subject matter disclosed herein addresses these issues by providing a method and system that allow a device caretaker to monitor the refueling status of a device.

A device fueling status monitor and alarm includes: a portable powered device; a refueling energy source adapted to refuel the portable powered device; a monitor associated with either the portable powered device or the refueling energy source, wherein the monitor monitors conditions of the portable powered device or the refueling energy source to detect alarm conditions, wherein the monitored conditions include the proximity of the portable powered device to the refueling energy source and whether the portable powered device is being refueled; an alarm condition transmitter associated with the monitor and adapted to transmit an alarm signal when alarm conditions are recognized by the monitor; and an alarm condition receiver adapted to receive signals from the alarm condition transmitter and signal an alarm condition to a user.

A method of monitoring a device's fueling status includes the steps of: monitoring conditions of a portable powered device or a refueling energy source, including monitoring at least the proximity of the portable powered device to the refueling energy source and whether the portable powered device is being refueled; detecting alarm conditions based on the monitored conditions; and transmitting a detected alarm condition to a remote receiver adapted to signal the alarm condition to a user.

A monitoring and alarm system includes: a powered portable device; a refueling energy source adapted to refuel the portable powered device; a monitor associated with either the portable powered device or the refueling energy source; a transmitter associated with the monitor and adapted to transmit an alarm signal when an alarm condition is recognized by the monitor; and a receiver adapted to receive signals from the alarm condition transmitter and signal the alarm condition to a user, wherein the alarm condition occurs when the monitor detects a predetermined functional condition of the powered portable device or the refueling energy source when the portable powered device is within a predetermined distance from the refueling energy source.

An advantage of the method and system provided herein is to provide an intelligent alarm system for a powered portable device.

Another advantage of the method and system provided herein is to provide intelligent monitoring of the refueling status of a powered portable device.

A further advantage of the method and system provided herein is to provide a communication hub for conditions related to a powered portable device.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a block diagram illustrating a device fueling status monitor and alarm system.

FIG. 2 is flow chart illustrating a method for implementing a device fueling monitor and alarm.

### DETAILED DESCRIPTION OF THE INVENTION

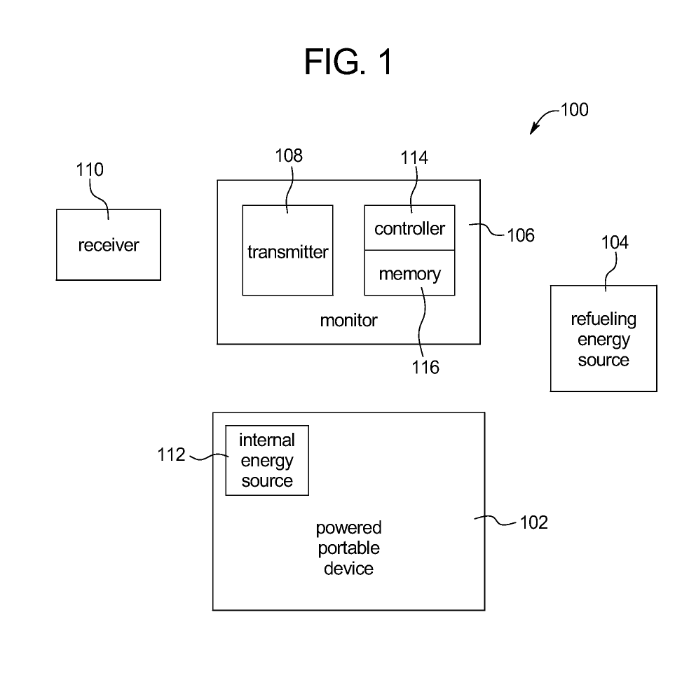

FIG. 1 illustrates a device fueling status monitor and alarm system 100 (the system 100). As shown in FIG. 1, the system 100 includes: a portable powered device 102; a refueling energy source 104; a monitor 106; a transmitter 108; and a receiver 110.

In the example shown in FIG. 1, a device fueling status monitor and alarm system 100 includes: a portable powered device 102; a refueling energy source 104 adapted to refuel the portable powered device 102; a monitor 106 for monitoring conditions of the portable powered device 102 or the refueling energy source 104 to detect alarm conditions, wherein the monitored conditions include the proximity of the portable powered device 102 to the refueling energy source 104 and whether the portable powered device 102 is being refueled; an alarm condition transmitter 108 associated with the monitor 106 and adapted to transmit an alarm signal when alarm conditions are recognized by the monitor 106; and an alarm condition receiver 110 adapted to receive signals from the alarm condition transmitter 108 and signal an alarm condition to a user.

As used herein, the term portable powered device 102 describes any device whose location relative to its refueling energy source 104 is not fixed and whose operation is not limited to a direct connection to the refueling energy source 104. In order for a portable powered device 102 to operate when disconnected from its refueling energy source 104, the portable powered device 102 must include an internal energy source 112, such as, for example, one or more batteries or capacitors. Accordingly, as used herein, a refueling energy source 104 is distinct from an internal energy source 112. The portable powered device 102 may rely on any refillable power source, such as, for example, electricity, gasoline, compressed natural gas, compressed air, hydrogen, etc.

For example, the typical desktop computer is not a portable powered device 102 as the term is used herein, as its operation relies on being plugged into a power outlet and does not include an internal energy source 112. However, the typical laptop computer is a portable powered device 102 as it includes a portable battery pack that functions as an internal energy source 112 that may be charged and recharged by AC adapter that plugs into an electrical outlet, which functions as the refueling energy source 104. Similarly, in an example wherein the portable powered device 102 is an electric vehicle, the internal energy source 112 would be the vehicle's battery or batteries and the refueling energy source 104 would be the recharging station used to recharge the vehicle's battery or batteries.

Other examples of portable powered devices 102 are: portable electronic devices, including phones, portable music devices, cameras, netbooks, tablets and laptop computers, etc.; cordless tools, including vacuums, drills, saws, lawnmowers, etc.; vehicles, including golf carts, go carts, all terrain vehicles, snowmobiles, mopeds, scooters, motorcycles, jet skis, boats, passenger vehicles, commercial vehicles, industrial equipment, farm equipment, construction equipment, etc. It is understood that the term portable powered device 102 as used herein describes any powered device with an internal power source that is capable of being recharged, refueled, refilled or repowered.

As used herein, a refueling energy source 104 is any energy, fuel, or power source used to recharge, refuel, refillable or repower the internal energy source 112 of the portable powered device 102. In an example using a rechargeable phone as the portable powered device 102, the refueling energy source 104 is the device that charges the phone's battery, not the battery itself. In an example using an electric vehicle as the portable powered device 102, the refueling energy source 104 is the charging station located, for example, in the user's garage, not the battery or batteries internal to the electric vehicle.

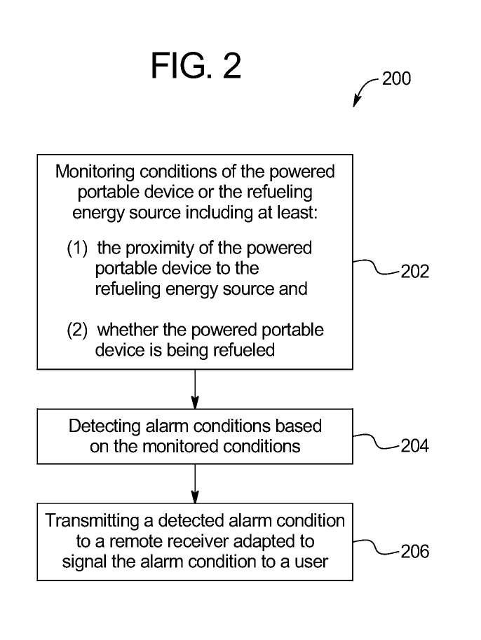

FIG. 2 illustrates a method for implementing a device fueling monitor and alarm (the method 200). As shown in FIG. 2, the method 200 includes the steps of: monitoring conditions of a portable powered device 102 or a refueling energy source 104, including at least the proximity of the portable powered device 102 to the refueling energy source 104 and whether the portable powered device 102 is being refueled 202; detecting alarm conditions based on the monitored conditions 204; and transmitting a detected alarm condition to a remote receiver 110 adapted to signal the alarm condition to a user 206.

The method 200 shown in FIG. 2, will now be described using the example of an electric passenger vehicle as the portable powered device 102 and an electric charging station as the refueling energy source 104.

As shown in FIG. 2, the first step in the method 200 is monitoring conditions of the portable powered device 102 or a refueling energy source 104, including at least the proximity of the portable powered device 102 to the refueling energy source 104 and whether the portable powered device 102 is being refueled 202. As shown in FIG. 1, the conditions of the portable powered device 102 and/or the refueling energy source 104 can be monitored using a monitor 106.

The monitor 106 may be provided within the portable powered device 102, within the refueling energy source 104, adapted to be associated with both devices or may be independently provided. For example, in one embodiment, the monitor 106 may include a portion integrated with the portable powered device 102 and another portion integrated with the refueling energy source 104, wherein the two potions communicate with each other to determine the distance between them. For example, the portable powered device 102 may include an RFID tag and the refueling energy source 104 may include an RFID reader such that their proximity may be monitored. Additionally, the monitor 106 may further be integrated with the portable powered device 102 to monitor whether it is being refueled or integrated within the refueling energy source 104 to monitor whether it is refueling. Additionally, the monitor 106 may monitor the status of the internal energy source 112, for example, to determine whether refueling is required.

It is contemplated that the portion of the monitor 106 associated with the portable powered device 102 may be directly or indirectly associated with the portable powered device 102. For example, a directly associated monitor 106 maybe incorporated into the portable powered device 102 itself, as described above with respect to the example using an RFID tag. An indirectly associated monitor 106 may monitor the location of an associated item as a proxy for the location of the portable powered device 102. For example, in embodiments in which the portable powered device 102 is an automobile, the key and/or fob may incorporate a portion of the monitor 106, such that the position of the key and/or fob is used as a proxy for the location of the portable powered device 102. Such adaptations may be dependant on the type of portable powered device 102 used in the system 100 and the number and types of devices and/or accessories associated with the powered portable device 102, as will be understood by one of ordinary skill in the art.

For example, when the portable powered device 102 is an automobile and the monitor 106 is incorporated, at least in part, into multiple keys and/or fobs (e.g., key one and key two), the monitor 106 may incorporate algorithms to track and monitor the typical pattern of key displacement, the data being incorporated into the monitoring process. For example, if key one is always near the refueling energy source 104 and key two comes and goes, then the monitoring process may learn to monitor key two for the alarm conditions. Additionally, each key may incorporate a switch to disable communication with the refueling energy source 104, which will enable an operator to selectively control which key should be used as a proxy for the car. The system 100 may be adapted such that when a key is turned off and on, the controller 114 updates and adapts the functions of the system 100 accordingly. Moreover, should an operator attempt to disable all of the keys adapted into the system 100, the operator may be alerted and/or prevented from doing so. Additionally, if the controller 114 determines there are no keys associated with the refueling energy source 104 after a predetermined amount of time, an alert condition may be signaled.

There are practically an unlimited number of conditions that may be monitored using the method 200 provided herein. However, for purposes of the example provided, the primary conditions monitored are (1) the distance between the portable powered device 102 and the refueling energy source 104 and (2) whether the refueling energy source 104 is refueling the portable powered device 102. By monitoring the distance between the portable powered device 102 and the refueling energy source 104 and whether the refueling energy source 104 is refueling the portable powered device 102, a user can ensure that the portable powered device 102 is being refueled anytime it is within a given range of the refueling energy source 104. In other words, being aware that the portable powered device 102 is within a given range of the refueling energy source 104, the user can ensure a refueling opportunity is not missed.

Whether the portable powered device 102 is being refueled can be monitored directly or indirectly. For example, the refueling status may be monitored directly via the portable powered device 102 by incorporating a portion of the monitor 106 that analyzes whether the fuel supply of the portable powered device 102 is increasing. For example, the monitor 106 may monitor the pathways that are a part of the portable powered device's refueling system. If those pathways are active, then the monitor 106 determines the portable powered device 102 is being refueled and communicates this status to the controller 114.

Similarly, the refueling status may be monitored directly via the refueling energy source 104 by incorporating a portion of the monitor 106 that analyzes whether the refueling energy source 104 is providing fuel to the portable powered device 102. For example, the monitor 106 may monitor whether the refueling power source 104 is having power drawn from it. When the portable powered device 102 is connected to the refueling power source 104 and begins to draw power from refueling power source 104 in a manner characteristic of the portable powered device 102, the monitor 106 may assume the refueling power source 104 is charging an associated portable powered device 102 and communicate this status to the controller 114. The monitor 106 may maintain this assumption as long as the refueling power source 104 is coupled with the portable powered device 102. Then, once the coupling is broken, the monitor 106 may assume the refueling power source 104 is no longer refueling the portable powered device 102 and communicate this status to the controller 114.

Alternatively, a portion of the monitor 106 may be integrated into the utility supplying the fuel to the refueling power source 104. The monitor 106 may then communicate to the controller 114 when the circuit supplying the fuel is active. It is understood that each of the example above are illustrative in purpose and may be employed singularly or in any combination with each other.

It is further contemplated that the subject matter disclosed herein provides other combinations of primary conditions and, in some embodiments, the proximity to the refueling energy source 104 and whether the refueling energy source 104 is refueling the portable powered device 102 may not be monitored at all. For example, the primary conditions may include: (1) monitoring the proximity of a first object to a location or other object and (2) monitoring a functional condition of the first or second object. Additional examples are provided herein.

The second step shown in FIG. 2, is detecting alarm conditions based on the monitored conditions 204. In order to detect the alarm conditions, a controller 114 may be incorporated within the monitor 106. In the example of the electric passenger vehicle 102 and electric charging station 104, an alarm condition may be triggered when the electric charging station 104 is within fifty feet of the electric charging station 104 and the electric passenger vehicle 102 is not being recharged (in the instance in which the monitor 106 is integrated with the electric passenger vehicle 102), the electric charging station 104 is not charging a portable powered device 102 (in the instance in which the monitor 106 is integrated with the electric charging station 104) or both (in the instance in which the monitor 106 is integrated with both the electric passenger vehicle 102 and the electric charging station 104.

In another example, an alarm condition may be triggered when the electric charging station 104 is within fifty feet of the electric charging station 104, the electric passenger vehicle 102 is below a threshold power level and the electric passenger vehicle 102 is not being recharged (in the instance in which the monitor 106 is integrated with the electric passenger vehicle 102), the electric charging station 104 is not charging a portable powered device 102 (in the instance in which the monitor 106 is integrated with the electric charging station 104) or both (in the instance in which the monitor 106 is integrated with both the electric passenger vehicle 102 and the electric charging station 104.

As shown in FIG. 2, the method 200 may further include the step of transmitting a detected alarm condition to a remote receiver 110 adapted to signal the alarm condition to a user 206. As shown in FIG. 1, the monitor 106 may include an alarm condition transmitter 108 functionally controlled by the controller 114. Accordingly, when triggered by a detected alarm condition, the alarm condition transmitter 108 may communicate the alarm condition to the remote receiver 110. It is understood that the alarm condition transmitter 108 and the remote receiver 110 are not always required in the system 100 and that there may be examples in which the alarm conditions are indicated locally in the portable powered device 102, the refueling energy source 104 and/or the monitor 106. It is further contemplated that the remote receiver 110 may be a dongle, a fob, an SMS enabled device, an internet enabled device or any other electronic mechanism adapted to receive an alarm signal from the monitor 106, whether wired or wirelessly. It is also contemplated that the remote receiver 110 may be a portable or stationary device.

The remote receiver 110 may provide an alarm notice to a user in any manner as will be appreciated by one of ordinary skill in the art, whether the alarm notice is visual, audio, tactile or otherwise. For example, a dongle configured as a remote receiver 110 may provide a visual alert, such as, for example a blinking light. In another example, a cellular phone configured as a remote receiver 110 may receive an SMS message and sound a predetermined audio alert. Further, if the remote receiver 110 is adapted within the dashboard or control panel of a vehicle, it may signal via a visual alert, an audio alert or a combination of both. The remote receiver 110 may be incorporated into a plurality of elements in the system 100 which may operate in combination to alert a user. For example, the portable powered device 102 and the refueling power source 104 may be configured to provide low level direct alerts when an alarm condition is triggered such as, for example, simple lights flashing and/or low intensity beeps, while a key chain device may be adapted to provide higher level alerts, such as, for example, a high pitched noise and the display of information on a screen or via indicator lights. Further, the transmitter 108 may be adapted to communicate via the internet via any of the multitudes of wireless technologies or via a direct connection to communicate a tweet, update a remote database, send an e-mail message, and/or update a web-based application, etc. As can be seen, there are numerous adaptations of remote receivers 110 that may be employed.

In one example, when the monitor 106 detects the powered portable device 102 is in proximity to the refueling energy source 104 and further detects that the powered portable device 102 is not being refueled, the system 100 may alert the user via the remote receiver 110. The alert may be a progressive alert. For example, at its lowest level, the alert may be a combination of just noticeable audio and/or visual alerts coming from the powered portable device 102, a remote receiver 110 adapted within the powered portable device 102, an independent remote receiver 110 (e.g., a keychain device), and/or a remote receiver 110 adapted within the refueling energy source 104. As time passes, the alert may get more intense and more difficult for a user to ignore or miss. Additionally, the user may be provided an opportunity to turn off or on or pause the alarm. Such functionality may be particularly beneficial in situations in which the user may have purposefully opted to not recharge the portable powered device 102. In such an instance case, being able to disable the alarm permanently or for a set amount of time may be advantageous.

The method 200 described herein can be used to monitor any number of alarm conditions. Using the electric passenger vehicle example above, additional alarm conditions may include, for example, whether the vehicle's doors are locked, whether the garage door is open, whether the vehicle's lights are on, whether the fuel level is below a certain threshold, etc. Additionally, remote operation to address many of these alarm conditions may also be executed (e.g., close the garage door, lock the car doors, turn off the lights, etc.) by the further integration of the monitor 106 and controller 114 into the portable powered device 102, the refueling energy source 104 and any ancillary devices.

It in contemplated that the controller 114 may function as a hub to provide a complete ecosystem of portable powered device 102 monitoring. For example, if the portable powered device 102 is an automobile, each door and window within an associated garage may have a portion of the monitor 106 (or plurality of monitors 106) through which the controller 114 tracks whether the doors and windows are open or closed. Additionally, the monitor 106 may determine the status or each door, hood, trunk, and or hatchback (open, closed and locked, or closed and unlocked) of the automobile, whether any interior or exterior light is on, how much fuel is remaining on-board, the state (e.g., on, off, moving, idle, etc.) and environmental settings (e.g., A/C, heat, temperature, blower, etc.), audio settings, the position of its seats, minors, pedals, and/or other driver or passenger controlled adjustments, etc. For conditions that can be actively controlled by the system 100, the controller 114 can provide a command to change any of these settings.

To accomplish the user controlled functions of the system 100 described herein, the system may include a user interface adapted to work with the controller 114. The user interface may be included into any one or more elements of the system 100, such as, for example, the portable powered device 102, the refueling power supply 104, the monitor 106, the transmitter 108, the receiver 110, etc. The one or more user interfaces may be used to configure the system 100, view the history of the system 100, receive alerts from the system 100 or cause actions within the system 100. The user interface may take any form and include various levels of capabilities as best fits its form factor. For example, the user interface may take the form of a key chain device and subsume the role currently played by the door lock/unlock device currently in use in most vehicles. The user interface may further take the form of a mobile device, such as a cell phone, tablet, netbook, etc. Accordingly, the user interface may include a dedicated application installed on it or may be able to communicate with an internet based control. Alternatively, the user interface may take the form of a computer.

Although described in the example above as a one to one relationship, a single portable powered device 102 may have a relationship with more then one refueling energy source 104 (e.g., one at home, one at work, a public access refueling energy source 104, a refueling energy source 104 offered by a utility or business concern, etc.). Similarly, a single refueling energy source 104 may have a relationship with more than one portable powered device 102.

As shown in FIG. 1, the system 100 may includes a controller 114 and associated memory 116. The controller 114 runs a variety of application programs, accesses and stores data, and controls the monitor 106, transmitter 108 and receiver 110. While further description of the controller 114 is provided below, it is understood that the controller 114 may be embodied in any one or more electronic systems arranged to control the electronic aspects of the system 100 and the method 200 described herein.

As shown by the above discussion, aspects of the system 100 are controlled by a controller 114. Typically, the controller 114 is implemented by one or more programmable data processing devices. The hardware elements operating systems and programming languages of such devices are conventional in nature, and it is presumed that those skilled in the art are adequately familiar therewith.

For example, the controller 114 may be a central control processing system utilizing a central processing unit (CPU), memories and an interconnect bus. The CPU may contain a single microprocessor, or it may contain a plurality of microprocessors for configuring the CPU as a multi-processor system. The memories include a main memory, such as a dynamic random access memory (DRAM) and cache, as well as a read only memory, such as a PROM, an EPROM, a FLASH-EPROM, or the like. The system also includes mass storage devices when appropriate. In operation, the main memory stores at least portions of instructions for execution by the CPU and data for processing in accord with the executed instructions.

The controller 114 may also include one or more input/output interfaces for communications with one or more processing systems. Although not shown, one or more such interfaces may enable communications via a network, e.g., to enable sending and receiving instructions electronically. The physical communication links may be wired or wireless.

The controller 114 may further include appropriate input/output ports for interconnection with one or more output displays (e.g., monitors, printers, etc.) and one or more input mechanisms (e.g., keyboard, mouse, voice, touch, bioelectric devices, etc.) serving as the one or more user interfaces for the controller 114. For example, the controller 114 may include a graphics subsystem to drive an output display. The links of the peripherals to the system may be wired connections or use wireless communications.

Those skilled in the art will recognize that the controller 114 also encompasses systems such as host computers, servers, workstations, network terminals, and the like. In fact, the use of the term controller 114 is intended to represent a broad category of components that are well known in the art.

Hence aspects of the system 100 and the method 200 discussed herein encompass hardware and software for controlling the relevant functions. Software may take the form of code or executable instructions for causing a controller 114 or other programmable equipment to perform the relevant steps, where the code or instructions are carried by or otherwise embodied in a medium readable by the controller 114 or other machine. Instructions or code for implementing such operations may be in the form of computer instruction in any form (e.g., source code, object code, interpreted code, etc.) stored in or carried by any readable medium.

As used herein, terms such as computer or machine “readable medium” refer to any medium that participates in providing instructions to a processor for execution. Such a medium may take many forms, including but not limited to, tangible storage media, as well as carrier wave and tangible transmission media. Non-volatile storage media include, for example, optical or magnetic disks, such as any of the storage devices in any computer(s) shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD, any other optical medium, punch cards paper tape, any other physical medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

It should be noted that various changes and modifications to the presently preferred embodiments described herein will be apparent to those skilled in the art. Such changes and modifications may be made without departing from the spirit and scope of the present invention and without diminishing its attendant advantages.

I claim:

1. A device fueling status monitor and alarm comprising:
a portable powered device;
a refueling energy source adapted to refuel the portable powered device;
a monitor associated with either the portable powered device or the refueling energy source, wherein the monitor monitors conditions of the portable powered device or the refueling energy source to detect alarm conditions, wherein the monitored conditions include the proximity of the portable powered device to the refueling energy source and whether the portable powered device is being refueled;
an alarm condition transmitter associated with the monitor and adapted to transmit an alarm signal when alarm conditions are recognized by the monitor; and
an alarm condition receiver adapted to receive signals from the alarm condition transmitter and signal an alarm condition to a user.

2. The device fueling status monitor and alarm of claim 1 wherein the portable powered device is a vehicle.

3. The device fueling status monitor and alarm of claim 1 wherein the portable powered device is a portable electronic device.

4. The device fueling status monitor and alarm of claim 1 wherein the refueling energy source is adapted to provide electricity to the portable powered device.

5. The device fueling status monitor and alarm of claim 1 wherein the monitor is associated with the portable electronic device.

6. The device fueling status monitor and alarm of claim 1 wherein the monitor is associated with the refueling energy source.

7. The device fueling status monitor and alarm of claim 1 wherein the monitor monitors the proximity of the portable powered device to the refueling energy source directly.

8. The device fueling status monitor and alarm of claim 1 wherein the monitor monitors the proximity of the portable powered device to the refueling energy source via a proxy.

9. The device of claim 1 wherein the alarm condition receiver is associated with the portable electronic device.

10. The device of claim 1 wherein the alarm condition receiver is independent of the portable electronic device.

11. A method of monitoring a device's fueling status, comprising the steps of:
monitoring conditions of a portable powered device or a refueling energy source, including monitoring at least the proximity of the portable powered device to the refueling energy source and whether the portable powered device is being refueled;
detecting alarm conditions based on the monitored conditions; and
transmitting a detected alarm condition to a remote receiver adapted to signal the alarm condition to a user.

12. The method of claim 11 wherein the step of monitoring conditions of a portable powered device or a refueling energy source includes monitoring the power status of the portable powered device.

13. The method of claim 12 wherein monitoring the power status includes monitoring whether the portable powered device is on, off, in standby or in active use.

14. The method of claim 11 wherein the step of monitoring conditions of a portable powered device or a refueling energy source includes monitoring security functions of the portable powered device.

15. The method of claim 14 where monitoring security functions of the portable powered device includes whether the powered portable device has its security features enabled.

16. A monitoring and alarm system comprising:
a powered portable device;
a refueling energy source adapted to refuel the portable powered device;
a monitor associated with either the portable powered device or the refueling energy source;
a transmitter associated with the monitor and adapted to transmit an alarm signal when an alarm condition is recognized by the monitor; and
a receiver adapted to receive signals from the alarm condition transmitter and signal the alarm condition to a user, wherein the alarm condition occurs when the monitor detects a predetermined functional condition of the powered portable device or the refueling energy source when the portable powered device is within a predetermined distance from the refueling energy source.

17. The monitoring and alarm system of claim 16 wherein the powered portable device is an automobile.

18. The monitoring and alarm system of claim 16 wherein the monitor is associated with the powered portable device.

19. The monitoring and alarm system of claim 16 wherein the transmitter is associated with the powered portable device.

20. The monitoring and alarm system of claim 16 wherein the receiver is associated with the powered portable device.
